(19) United States
(12) Patent Application Publication
(10) Pub. No.: US 2005/0224770 A1
(43) Pub. Date: Oct. 13, 2005

(54) Flexible screw type height control device

(76) Inventors: Munsang Kim, Seoul (KR); Yoha Hwang, Seoul (KR); Seung-Jong Kim, Seoul (KR); Jong Min Lee, Siheung-si (KR); Sung-Kee Park, Seoul (KR); Jong-Suk Choi, Seoul (KR)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/780,966

(22) Filed: Feb. 17, 2004

(51) Int. Cl. F16H 25/18

(52) U.S. Cl. 254/98

(57) ABSTRACT

A flexible screw type height control device comprises a housing, a servomotor mounted in the housing, a driving gear which is rotated by the servomotor, a driven gear which is provided with a spiral groove at a central portion thereof and is tooth-engaged with the driving gear, a flexible screw member which passes axially through the spiral groove of the driven gear and moves linearly upward and downward by the servomotor, and a telescopic unit including a plurality of sliding members which are slidably coupled to each other and cooperate with the flexible screw member. The flexible screw member is a coil spring. A first sliding member is slidably disposed in the housing. One end of the flexible screw member is extended outside the housing, and the other end is fixed to a last sliding member. Each sliding member is formed as an open-ended pipe and a cross-sectional area of the sliding members decreases from the first sliding member to the last sliding member.

### FIELD OF THE INVENTION

The present invention relates to a height control device, and particularly to a flexible screw type height control device for moving an object upward and downward.

### BACKGROUND OF THE INVENTION

Generally, a height control device for moving an object upward and downward is applicable to various industrial equipment. An example of such a height control device is disclosed in U.S. Pat. No. 4,682,930, which will be described with reference to FIG. 1.

As shown in the drawing, motor 6 is fixed on frame 1. Toothed wheel 36 is fixed on a driving shaft of motor 6. Toothed wheel 36 is connected with toothed wheel 31 rotatably supported on frame 1 through toothed belt 32. Spline shaft 33 is inserted into toothed wheel 31 axially movably, and is supported rotatably on intermediate frame 7 through bearings.

Ball nut 4 is fixed on frame 1, and first ball screw 5 is inserted into ball nut 4 so as to rotate and move linearly.

Ball nut 8 is supported on intermediate frame 7. Second ball screw 9 is inserted into ball nut 8 so as to rotate and move linearly, with respect to ball nut 8. Both ends of second ball screw 9 are rotatably supported on lift frame 10 supporting chuck 3 for clamping an object.

Toothed wheel 34, toothed wheel 11 and toothed wheel 12 are fixed on spline shaft 33, first ball screw 5 and second ball screw 9, respectively. Toothed wheels 34, 11 and 12 are connected with each other by toothed belt 35.

When spline shaft 33 is rotated by motor 6, first ball screw 5 and second ball screw 9 are rotated synchronously with the rotation of spline shaft 33, and move linearly on ball nuts 4 and 8, respectively. Accordingly, intermediate frame 7, lift frame 10 and chuck 3 move linearly.

However, the prior art height control device has a problem of a relatively limited stroke of the chuck, which is restricted to within the lengths of the ball screws.

Further, since the driving mechanism of the prior art includes a number of components such as ball screws, ball nuts, spline shaft, toothed wheels and so on, when two or more sets of the driving mechanism are assembled for the purpose of moving the chuck farther, the structure is complicated and the overall size and weight are increased. Also, a large load is applied to the device, causing deterioration of the operational stability.

### SUMMARY OF THE INVENTION

It is an object of the present invention to overcome the problems in the prior art and provide a flexible screw type height control device capable of a relatively long stroke while simplifying the structure and minimizing size.

In order to achieve the above object, the present invention provides a flexible screw type height control device comprising a housing; a servomotor mounted in the housing; a driving gear, which is rotated by the servomotor; a driven gear, which is provided with a spiral groove at a central portion thereof and is tooth-engaged with the driving gear; a flexible screw member, which passes axially through the spiral groove of the driven gear and moves linearly upward and downward by the servomotor; and a telescopic unit including a plurality of sliding members, which are slidably coupled to each other and cooperate with the flexible screw member.

The flexible screw member is a coil spring.

A first sliding member of the plurality of sliding members is slidably disposed in the housing. One end of the flexible screw member is extended outside the housing, and the other end of the flexible screw member is fixed to a last sliding member of the plurality of sliding members.

Each sliding member is formed as an open-ended pipe and a cross-sectional area of the sliding members decreases from the first sliding member to the last sliding member.

The cross-section of the pipe is shaped as a circle or a polygon.

### BRIEF DESCRIPTION OF DRAWINGS

The above object and features of the present invention will become more apparent from the following description of the preferred embodiments given in conjunction with the accompanying drawings.

FIG. 1 is a front view of a conventional height control device.

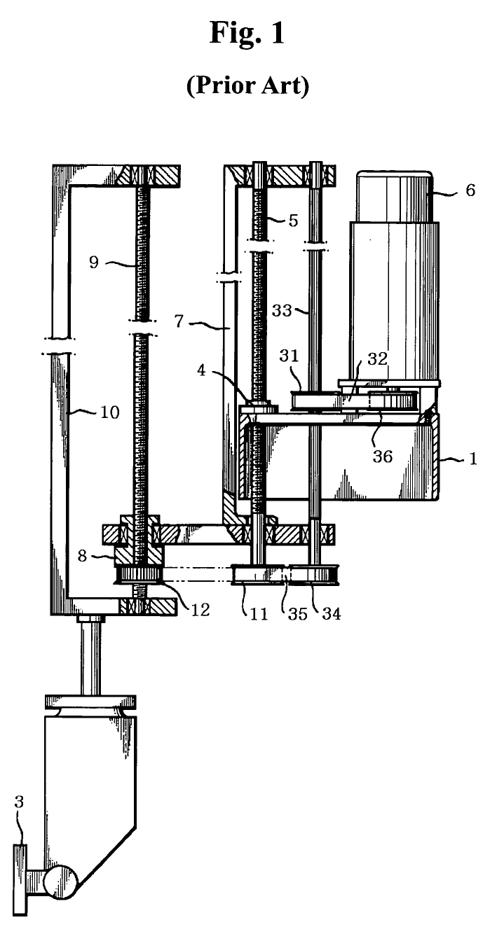

FIG. 2 is a cross-sectional view showing a completely extracted state of a flexible screw type height control device in accordance with an embodiment of the present invention.

FIG. 3 is a cross-sectional view showing a completely retracted state of the flexible screw type height control device in accordance with an embodiment of the present invention.

FIG. 4 is a perspective view showing a telescopic unit of a flexible screw type height control device in accordance with another embodiment of the present invention.

FIG. 5 is a perspective view showing a completely retracted state of the telescopic unit of the flexible screw type height control device in accordance with another embodiment of the present invention.

### DETAILED DESCRIPTION OF THE PRESENT INVENTION

Preferred embodiments of the present invention will now be described with reference to the accompanying drawings.

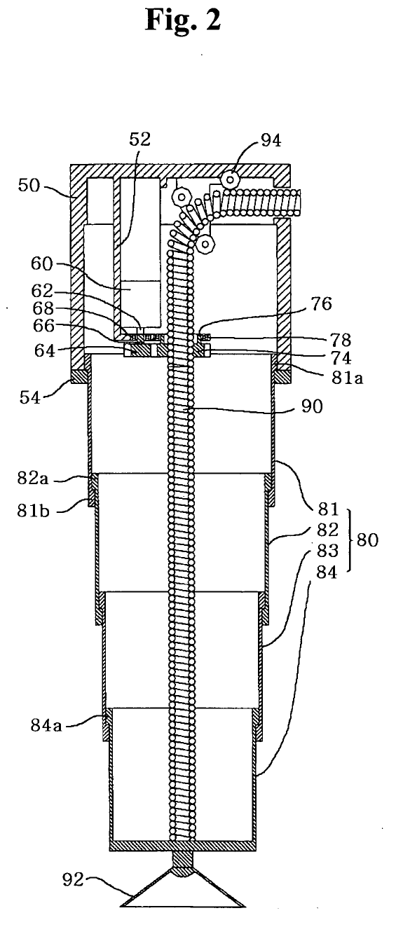

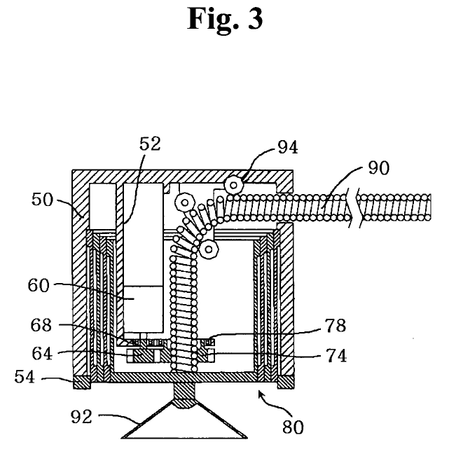

FIGS. 2 and 3 are cross-sectional views showing a completely extracted state and a completely retracted state, respectively, of a flexible screw type height control device in accordance with an embodiment of the present invention.

As shown in the drawings, servomotor 60 is mounted in cylindrical housing 50, supported by support frame 52. The top end of housing 50 is closed, and the bottom is opened.

Driving shaft 62 of servomotor 60 is extended downward, and driving gear 64 is fixed thereto. Bush 66 of driving gear 64 is supported rotatably on support frame 52 through bearing 68.

Driven gear 74 is tooth-engaged with driving gear 64, and bush 76 of driven gear 74 is supported rotatably on support frame 52 through bearing 78.

Telescopic unit 80 including a plurality of sliding members 81 to 84 is provided at the open end of housing 50. Each sliding member is shaped as an open-ended cylindrical pipe, and a cross-sectional area thereof decreases from first pipe 81 to last pipe 84.

In other words, first pipe 81 slides into and out of housing 50, and second pipe 82 slides into and out of first pipe 81. Likewise, third and fourth pipes 83 and 84 slide into and out of second and third pipes 82 and 83, respectively. The number of sliding members 81 to 84 in this embodiment is four, which can be varied.

Stopper 54 is formed protrudingly inward around the open end of housing 50 while contacting the outer periphery surface of first pipe 81. Hook 81a is formed around the outer periphery surface of the upper end of first pipe 81. Therefore, the separation of first pipe 81 from housing 50 is prevented by hook 81a being in contact with stopper 54 when first pipe 81 is extracted completely from housing 50.

In the same manner, stopper 81b is formed around the inner periphery surface of the lower end of first pipe 81, contacting second pipe 82, and hook 82a is formed around the outer periphery surface of the upper end of second pipe 82. In other words, each pipe is provided with a hook and a stopper at its upper and lower ends, respectively.

However, lowermost fourth pipe 84 only has hook 84a around the outer periphery surface of its upper end. Means 92 for grasping an object is attached to the lower surface of fourth pipe 84. Grasping means 92 may be implemented as a vacuum cup and the like.

Flexible screw member 90 for extracting or retracting telescopic unit 80 is provided in housing 50 and telescopic unit 80. Preferably, flexible screw member 90 is implemented as a coil spring having a certain stiffness.

Flexible screw member 90 is extended in parallel with a sliding axis of telescopic unit 80, and passes through the central portion of driven gear 74.

A spiral groove (not shown) is formed at the central portion of driven gear 74. Flexible screw member 90 is engaged with the spiral groove.

An upper portion of flexible screw member 90 is bent and extended outside housing 50 through a side wall of housing 50, and the lower end of flexible screw member 90 is fixed to the bottom of lowermost fourth pipe 84. For smooth movement of flexible screw member 90, rollers 94 for supporting and guiding the bent portion of flexible screw member 90 are mounted in housing 50.

When driven gear 74 is rotated by servomotor 60 in a direction or in reverse, flexible screw member 90 moves linearly downward or upward by the spiral groove formed at driven gear 74. But, the rotation of flexible screw member 90, the lower end of which is fixed to fourth pipe 84, is prevented. If pipes 81 to 84 and flexible screw member 90 could be rotated together, they can not move linearly or the moving efficiency may be considerably deteriorated.

In order to prevent the rotation of pipes 81 to 84, a recess (not shown) is longitudinally provided at the outer surface of first to fourth pipes 81 to 84 along the sliding direction of telescopic unit 80, and a protrusion (not shown) corresponding to the recess is formed at the inner surface of housing 50 and first to third pipes 81 to 83, in such a manner that the protrusion of housing 50 is received in the recess of first pipe 81 and the protrusion of first pipe 81 is received in the recess of second pipe 82. These recesses and protrusions permit the sliding movement but not rotation of the pipes. Since such rotation preventing structures are well-known, other modifications may be applied.

When the cross-section of the sliding members 81 to 84 is shaped as a polygon, the above rotation preventing structure is unnecessary as the polygonal shape is capable of restraining the relative rotation to the adjacent sliding member.

Flexible screw member 90, which is implemented as a coil spring, is set to have an adequate stiffness considering the weight of the object to be grasped, and absorbs a shock due to the load applied to the device during operation. In addition, flexible screw member 90 can be extended in any direction of housing 50 or wounded around housing 50 according to the mounting condition of the inventive height control device.

Flexible screw member 90 may serve as a passage for a hydraulic or pneumatic hose or an electric wire passing therethrough.

The operational effect of the flexible screw type height control device according to an embodiment of the present invention will now be described with reference to FIGS. 2 and 3.

When servomotor 60 operates to rotate driving shaft 62 in a direction, driving gear 64 and driven gear 74 are rotated.

As driven gear 74 is rotated, flexible screw member 90, which passes through the spiral groove formed at the central portion of driven gear 74, moves downward linearly. Thus, telescopic unit 80 is extracted in such a manner that first pipe 81 slides out of housing 50 and second to fourth pipes 82 to 84 slide out of first to third pipes 81 to 83, respectively, so that grasping means 92 can reach the object.

When telescopic unit 80 is completely extracted as shown in FIG. 2, hook 81a formed around the outer periphery surface of the upper end of first pipe 81 contacts stopper 54, which is formed protrudingly inward around the open end of housing 50. Similarly, hooks formed at second to fourth pipes 82 to 84 contact stoppers, which are formed at first to third pipes 81 to 83, respectively. Therefore, the separation of pipes 81 to 84 from each other is prevented.

When servomotor 60 operates to rotate driving shaft 62 in a direction reverse to the extraction, driving gear 64 and driven gear 74 are also rotated in reverse, so flexible screw member 90 moves upward linearly by the spiral groove formed at the central portion of driven gear 74, through which flexible screw member 90 passes. The upper portion of flexible screw member 90 retreats out of housing 50 through the side wall guided by rollers 94.

Accordingly, telescopic unit 80 is in a completely retracted state as shown in FIG. 3, where all pipes 81 to 84 are received in housing 50, thereby minimizing the size of the device.

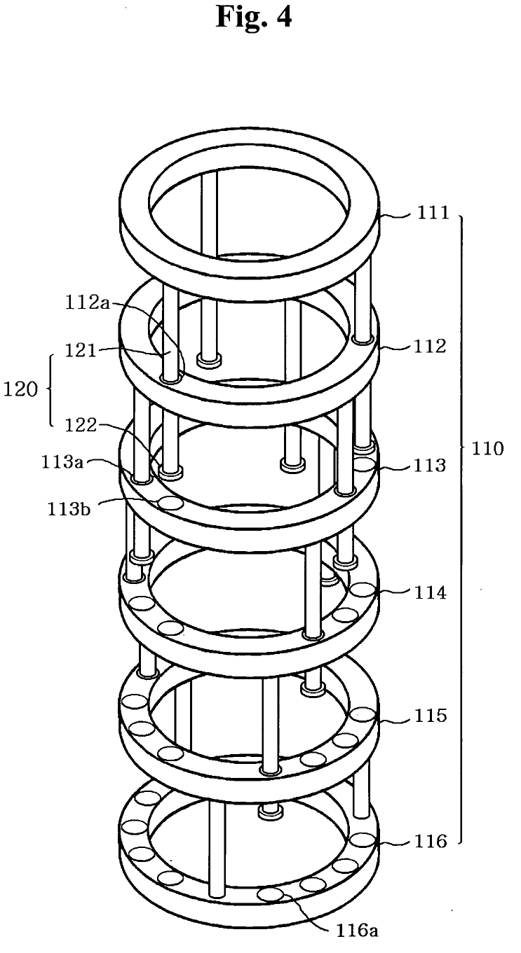

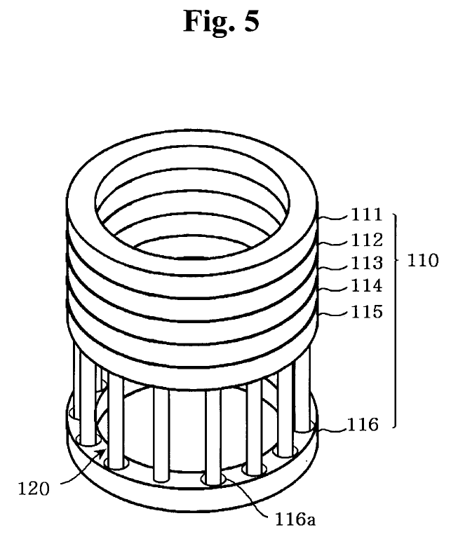

FIGS. 4 and 5 are perspective views showing an extracted state and a retracted state of a telescopic unit of a flexible screw type height control device in accordance with another embodiment of the present invention, respectively.

As shown in the drawings, a flexible screw type height control device in accordance with another embodiment of the present invention comprises a telescopic unit 110 including a plurality of ring-shaped sliding members 111 to 116. Preferably, the number of sliding members is six, which however can be varied. Since the remaining components including housing, servomotor, driving gear, driven gear, flexible screw member and so on, of the height control device in accordance with this embodiment are same as those of device in accordance with the previous embodiment, the illustrations and explanations thereof will be omitted.

First to fifth sliding members 111 to 115, except lowermost sixth sliding member 116, are provided with one or more support rods 120, which are extended toward the next sliding members.

Uppermost first sliding member 111 is disposed in housing 50 and prevented from being separated from housing 50 by stopper 54 (See FIG. 2). The lower end of flexible screw member 90 is fixed to the lowermost sixth sliding member 116.

Support rod 120 includes cylindrical body 121 and enlarged stepped part 122, which is detachably coupled to the bottom of body 121.

Second sliding member 112 next to first sliding member 111 is provided with first through-hole 112a through which body 121 of support rod 120 formed at first sliding member 111 passes. The diameter of first through-hole 112a is larger than that of body 121 of support rod 120, but smaller than that of stepped part 122. This is to prevent second sliding member 112 from being separated from first sliding member 111, while permitting body 121 of support rod 120 to slide through hole 112a.

Third sliding member 113 next to second sliding member 112 is provided with first through-hole 113a through which body 121 of support rod 120 formed at second sliding member 112 passes and second through-hole 113b through which stepped part 122 of support rod 120 formed at first sliding member 111 passes. The diameter of first through-hole 113a is larger than that of body 121 of support rod 120, but smaller than that of stepped part 122. However, the diameter of second through-hole 113b is larger than that of stepped part 122.

In the same manner, third to fifth sliding members 113 to 115 are also provided with first and second through-holes.

The lower end of support rod 120 formed at fifth sliding member 115 is fixedly coupled to lowermost sixth sliding member 116.

As shown in FIG. 5, when telescopic unit 110 is in a completely retracted state, first to fifth sliding members 111 to 115 are piled upon one another, and stepped parts 122 of support rods 120 of first to fourth sliding members 111 to 114 are received into recesses 116a, which are provided at sixth sliding member 116.

Support rods 120 restrain sliding members 111 to 116 and flexible screw member 90 from being rotated during movement upward and downward.

Preferably, the number of support rods 120 formed at each sliding member is three, considering the size and weight of telescopic unit 110 and exterior shock during operation.

Since the operational effect of the flexible screw type height control device in accordance with this embodiment is same as that in accordance with the previous embodiment, an explanation thereof will be omitted.

As described above in detail, the inventive flexible screw type height control device has a simple operational structure between the servomotor and the flexible screw member and between the sliding members disposed adjacent to each other, and can maximize the stroke, i.e., ratio of the height in a completely extracted state to that in a completely retracted state of the telescopic unit.

In addition, the flexible screw member, which is implemented as a coil spring, can absorb a shock due to the load during operation to protect the device, and can be bent and extended in any direction of the housing according to the mounting conditions.

While the present invention has been shown and described with respect to particular embodiments, it will be apparent to those skilled in the art that many changes and modifications may be made without departing from the spirit and scope of the invention as defined in the appended claims.

1. A flexible screw type height control device, comprising:
a housing;
a servomotor mounted in the housing;
a driving gear, which is rotated by the servomotor;
a driven gear, which is provided with a spiral groove at a central portion thereof and is tooth-engaged with the driving gear;
a flexible screw member, which passes axially through the spiral groove of the driven gear and moves linearly upward and downward by the servomotor; and
a telescopic unit including a plurality of sliding members, which are slidably coupled to each other and cooperate with the flexible screw member.

2. The flexible screw type height control device of claim 1, wherein the flexible screw member is a coil spring.

3. The flexible screw type height control device of claim 1, wherein a first sliding member of the plurality of sliding members is slidably disposed in the housing,
one end of the flexible screw member is extended outside the housing, and the other end of the flexible screw member is fixed to a last sliding member of the plurality of sliding members.

4. The flexible screw type height control device of claim 3, wherein each sliding member is formed as an open-ended pipe and a cross-sectional area of the sliding members decreases from the first sliding member to the last sliding member.

5. The flexible screw type height control device of claim 4, wherein the telescopic unit is received in the housing when the telescopic unit is in a completely retracted state.

6. The flexible screw type height control device of claim 4, wherein the cross-section of the pipe is shaped as a circle.

7. The flexible screw type height control device of claim 4, wherein the cross-section of the pipe is shaped as a polygon.

8. The flexible screw type height control device of claim 3, wherein each sliding member has a ring shape,
the sliding members before the last sliding member are provided with at least one support rod, which is extended toward the next sliding member, and
the sliding members after the first sliding member are provided with at least one first through-hole through which the support rod of the prior sliding member passes.

9. The flexible screw type height control device of claim 8, wherein the sliding members after the second sliding member are provided with at least one second through-hole through which the support rod of the prior sliding members passes.

10. The flexible screw type height control device of claim 9, wherein the support rod includes a cylindrical body and an enlarged stepped part, which is detachably coupled to the bottom of the body,
the diameter of the first through-hole is larger than that of the body of the support rod, but smaller than that of the stepped part, and
the diameter of the second through-hole is larger than that of the stepped part.

11. The flexible screw type height control device of claim 1, further comprising rollers, which are mounted in the housing for guiding the movement of the flexible screw member.
